(19) United States
(12) Patent Application Publication
(10) Pub. No.: US 2010/0106953 A1
(43) Pub. Date: Apr. 29, 2010

(54) METHOD FOR PATCHING ROM BOOT CODE

(75) Inventors: Tomer Yosef Morad, Tel Aviv (IL); Shlomo Finestein, Golan Heights (IL); Ami Emanoel Hazbany, Ra'anana (IL); Vadim Kogan, Ramla (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: HORIZON SEMICONDUCTORS LTD., Herzliya (IL)

(21) Appl. No.: 12/256,881

(22) Filed: Oct. 23, 2008

(51) Int. Cl. G06F 15/177; G06F 12/00; G06F 12/02

(52) U.S. Cl. 713/2; 711/103; 711/E12.008

(57) ABSTRACT

The present invention relates to a method for patching a boot code stored on ROM comprising the steps of (a) storing at least one patching command for said boot code in a PROM; (b) loading said boot code from said ROM to a memory; (c) reading said at least one patching command from said PROM; (d) patching at least one command of said boot code residing in said memory with said at least one patching command from said PROM; and (e) executing the patched boot code.

### FIELD OF THE INVENTION

The present invention relates to the field of boot loaders. More particularly, the invention relates to a method for patching boot code, loaded from ROM, with contents from a PROM (Programmable ROM).

### BACKGROUND OF THE INVENTION

Today, a variety of SoCs (System on Chip) are used in many processing devices. A SoC generally comprises a processor embedded on a chip which is coupled to a local bus on the chip. Included on this single chip are also the hardware components required for a specific application, as well as other processors. SoCs are usually more application-specific than general integrated circuits. Typically, the SoC requires a boot code upon powering up. The boot (i.e. bootstrapping) process starts the operating systems when the user powers up the SoC. A boot sequence is the initial set of operations that the SoC performs when it is powered.

The boot code is typically stored in ROM for quick access, low complexity, spatial efficiency, low cost, and security reasons. The ROM, otherwise known as a masked ROM, has its code hardwired internally at the FAB (a semiconductor fabrication plant) and thus cannot be reprogrammed later. Because ROM resides on the SoC and is programmed in manufacturing, unauthorized access to the code within the ROM is difficult. This allows greater security against reverse engineering of proprietary code and against cryptographic attacks.

Along with the advantages in the use of ROM on SoCs there are major drawbacks. One such drawback is that the ROM fabricated on the SoC cannot be modified easily. Nevertheless, frequently, errors or “bugs” in the ROM code are discovered after the ROM has been fabricated on the SoC, these bugs must be addressed and repaired in order to ensure the integrity of the code and of the overall functioning of the SoC.

One method for repairing bugs is to make the necessary corrections in the ROM code, program a new ROM, and then re-fabricate the SoC. This method results in either scrapping the SoCs with the old ROMs that contain bugs or selling these SoCs at a reduced price for use in limited applications (i.e., those in which the known bugs have an insignificant impact on the application). This method of repairing bugs can be very expensive and time consuming. In addition, subsequent testing of the re-fabricated SoC may reveal additional bugs requiring another re-fabrication and additional expenses and delays.

In addition to the difficulties involved in repairing bugs in the ROM code, it is also complicated to add new features to the ROM code. Such additional features may be determined by the system designer to be desirable after the ROM has already been programmed and fabricated within the SoC.

Another type of memory storage is the OTP (One-Time Programmable), which is a PROM (Programmable ROM), designed for programming only once and cannot be reprogrammed. PROMs may be programmed with exposure to UV light, electric shock, etc. Thus, programming of the PROM can be done after the production of the chip, in a typical electronics lab or in the field. PROMs have an advantage over masked ROMs for system design purposes since the system designer has control over the programming of the PROM and can provide upgraded ROMs more readily. Nonetheless, PROMs are more expensive and more time consuming.

It is an object of the present invention to provide a method for modifying a boot code loaded from ROM.

It is another object of the present invention to provide a method for fixing bugs in a boot code stored on ROM.

It is still another object of the present invention to provide a method, for modifying the boot process, which is cost effective and time efficient.

It is still another object of the present invention to provide a SoC system with a modifiable boot process.

Other objects and advantages of the invention will become apparent as the description proceeds.

### SUMMARY OF THE INVENTION

The present invention relates to a method for patching a boot code stored on ROM comprising the steps of: (a) storing at least one patching command for said boot code in a PROM; (b) loading said boot code from said ROM to a memory; (c) reading said at least one patching command from said PROM; (d) patching at least one command of said boot code residing in said memory with said at least one patching command from said PROM; and (e) executing the patched boot code.

In one embodiment, the patching command includes two parameters: data and address.

In a different embodiment, the patching command includes three parameters: data, start address, and data-length.

Preferably, the PROM is an OTP.

In one embodiment the reading of the patching command(s) is preformed after starting to execute the boot code from the memory and as an execution command of said boot code.

The present invention also relates to a method for patching a boot code stored on ROM comprising the steps of: (a) storing at least one patching command for said boot code in a PROM; (b) storing a lookup table listing intended boot code address(es) of said at least one patching command in said PROM; (c) copying said lookup table from said PROM to a memory; (d) reading said lookup table from said memory; and (e) executing said boot code from ROM, while executing said at least one patching command from said PROM instead of at least one command of said boot code having said boot code address listed in said lookup table.

The present invention also relates to a method for patching a boot code stored on ROM comprising the steps of: (a) storing a lookup table, on a PROM, listing at least one patching command, and its intended boot code address, for patching said boot code; (b) copying said lookup table from said PROM to a memory; (c) reading said lookup table from said memory; and (d) executing said boot code from ROM, while executing said at least one patching command from said lookup table in memory instead of at least one command of said boot code having said boot code address listed in said lookup table.

The present invention also relates to a method for patching a boot code stored on ROM comprising the steps of: (a) storing a lookup table, on a PROM, listing at least one patching command, and its intended boot code address, for patching said boot code; (b) reading said lookup table from said PROM; and (c) executing said boot code from ROM, while executing said at least one patching command, from said lookup table in said PROM, instead of at least one command of said boot code having said boot code address listed in said lookup table.

The present invention also relates to a system for patching a boot code stored on ROM comprising: (a) a ROM for storing said boot code; (b) a PROM for storing patching commands; (c) a memory capable of storing said boot code and said patching commands; and (d) a controller for loading said boot code from said ROM to said memory, and for patching said boot code in said memory with patching commands from said PROM.

The present invention also relates to a system for patching a boot code stored on ROM comprising: (a) a ROM for storing said boot code; (b) a PROM for storing patching commands; (c) a memory capable of storing said boot code and said patching commands; (d) a controller for loading said boot code from said ROM to said memory; and (e) a processor for patching said boot code with said patching commands from said PROM and for executing the patched boot code.

### BRIEF DESCRIPTION OF THE DRAWINGS

In the drawings:

FIG. 1 is a block diagram depicting a part of the SoC according to an embodiment of the invention.

FIG. 2 is a flow chart illustrating the process of patching a boot code according to an embodiment of the invention.

FIG. 3 is a flow chart illustrating the process of patching a boot code according to another embodiment of the invention.

FIG. 4 is a flow chart illustrating the process of patching a boot code according to yet another embodiment of the invention.

### DETAILED DESCRIPTION OF PREFERRED EMBODIMENTS

All referrals to the term “patching” hereinafter are meant to include any one or any combination thereof of the following: modifying, replacing, amending, substituting, altering, changing, rewriting, adding, deleting, or any other act of causing the system to perform in a deviation from the initial designed process.

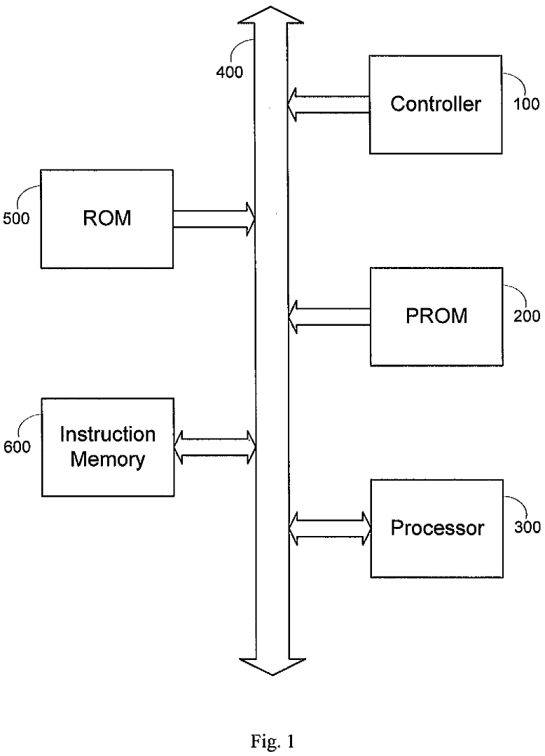

FIG. 1 is a block diagram depicting a part of the SoC according to an embodiment of the invention. In this embodiment the original boot code is first stored on ROM 500, during the manufacturing of the chip in the FAB. The patch, i.e. the patching commands, is preferably stored in PROM 200, where the patch may include bug fixes, new features, new data, or other alterations to the original boot code stored on ROM 500. The patch may be stored in a number of formats and ways, such as storing pairs of addresses and instructions, meaning, that a requested patching command is written as a new command with an attached address. This patching command is basically intended for replacing an old command from the original boot code having the same address. The programming of PROM 200 can be done in a different place than the factory producing the SoC, thus allowing the SoC designer to manufacture the SoC in a FAB and then, later on, program the PROM in his own lab, after the SoC has been manufactured. For example, the PROM 200 may be programmed after a new feature is requested or after a bug has been found in the original boot code stored in ROM 500. The PROM 200 may be an OTP, EPROM, EEPROM, EAROM, or any other known programmable memory, which can be programmed once or a number of times. Instruction Memory 600 may be any volatile memory used for loading and unloading data during processing, such as SRAM. When the SoC is powered, controller 100 transfers the boot code from ROM 500 into instruction memory 600, over bus 400, where the boot code awaits execution by processor 300. After the boot code is copied into instruction memory 600, the patching commands from the PROM 200 are read and copied into their intended place in instruction memory 600 replacing the corresponding commands from the original boot code loaded from ROM 500. Thus, when processor 300 finally executes the code from the instruction memory 600, it executes the new patched code. In other embodiments, ROM 500, PROM 200, instruction memory 600, and other parts of the SoC do not share the same bus, and may have different combinations of interconnecting buses.

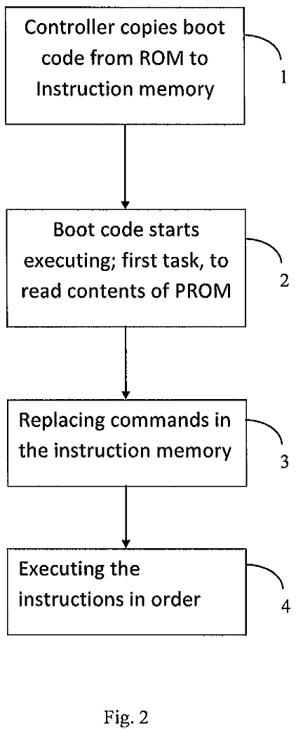

FIG. 2 is a flow chart illustrating the process of patching a boot code according to an embodiment of the invention. In step 1, after powering up the SoC, the controller 100 copies the boot code from the ROM 500 to the instruction memory 600, as described in relations to FIG. 1. In step 2, the processor 300 starts executing the boot code from instruction memory 600. The first task of the boot code is to read the patching commands from the PROM 200 and copy the patching commands, into instruction memory 600 in their intended addresses. Thus in step 3, the processor 300 copies the patching commands from PROM 200 and replaces the corresponding commands from the original boot code with the patching commands from the PROM 200. In step 4, the processor 300 continues executing the boot code, residing in instruction memory 600, in its set order, effectively executing a patched up boot code.

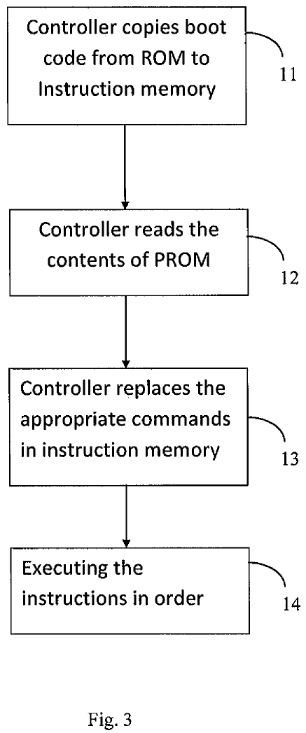

FIG. 3 is a flow chart illustrating the process of patching a boot code according to another embodiment of the invention. In step 11, after powering up the SoC, the controller 100 copies the boot code from the ROM 500 to the instruction memory 600, as described in relations to FIG. 1. In step 12, the controller 100 then reads the patching commands from PROM 200. In step 13, the controller 100 copies the patching commands from PROM 200 and replaces the corresponding commands from the original boot code in the instruction memory 600, loaded from ROM 500, with the patching commands from the PROM 200. In step 14, the processor 300 begins executing the boot code from start in its set order, effectively executing the patched up boot code.

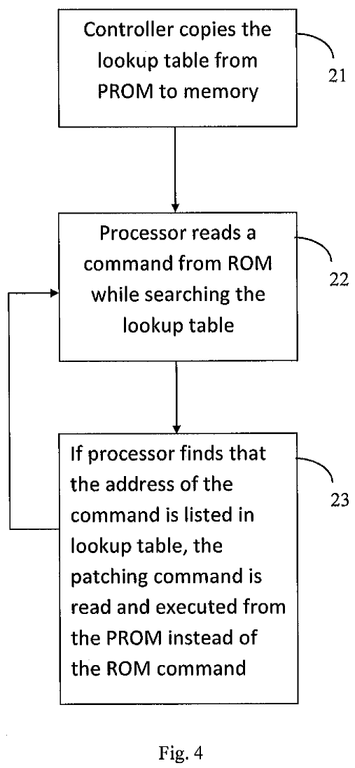

FIG. 4 is a flow chart illustrating the process of patching a boot code according to yet another embodiment of the invention. As described in relations to FIG. 1 the patching commands are programmed into PROM 200, nevertheless, in this embodiment a lookup table is also programmed into PROM 200 together with the patching commands. This lookup table is designed to list the addresses of commands, of the original boot code, which are intended for patching. In step 21, after powering up the SoC, the controller 100 copies the lookup table from PROM 200 to the instruction memory 600. In step 22, the processor 300 begins executing the boot code from ROM 500 while continuously reading the lookup table from instruction memory 600. The processor 300 continues reading and executing the boot commands until it reached an address of a command that is listed in the lookup table. In step 23, if the processor 300 reached an address that is listed in the lookup table, it reads and executes the corresponding patching command from PROM 200 instead of the original command from ROM 500. The processor 300 then continues executing the boot code from ROM 500 while continuously reading the lookup table from instruction memory 600 looking for patching commands. Steps 22 and 23 may continue continuously until the boot code execution is finished. Thus the executed boot code is in effect a patched up boot code.

In yet another embodiment, the process of patching a boot code is similar to the one described in relations to FIG. 4. However, in this embodiment the patching commands are copied together with the lookup table, listing the addresses, from PROM 200 into instruction memory 600. Thus, if the processor 300 reaches an address that is listed in the lookup table, it reads the corresponding patching command from the instruction memory 600 instead of the original command from ROM 500, effectively executing a patched up code.

In yet another embodiment, the process of patching a boot code is similar to the one described in relations to FIG. 4. However, in this embodiment there is no need for the instruction memory 600, and processor 300 reads the lookup table from PROM 200 directly and continually during the execution of the boot code from ROM 500. If the processor 300 reaches an address that is listed in the lookup table of PROM 200, it reads the corresponding patching command instead of the original command from ROM 500. Thus the executed boot code is in effect a patched up boot code.

In one of the embodiments the patching commands are stored each with two parameters, address and data; where each patching command has a corresponding address for specifying the intended location for patching with the patching data. In another embodiment the patching commands are stored each with three parameters in a format of start address, data-length and data. Thus each patching command, or a group of patching commands, has a start address and length for specifying their intended location and length for patching.

In a preferred embodiment PROM 200, as described in relations to FIG. 1, is designed as an OTP (One Time Programmable), for security reasons. Thus, once the OTP PROM 200 is programmed, no malicious or other foreign code can be added, where a malicious code can be a code designed to help reverse engineer the boot code, or for bypassing some of the restrictions programmed in the boot code.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the invention or exceeding the scope of claims,

1. A method for patching a boot code stored on ROM comprising the steps of:
a. storing at least one patching command for said boot code in a PROM;
b. loading said boot code from said ROM to a memory;
c. reading said at least one patching command from said PROM;
d. patching at least one command of said boot code residing in said memory with said at least one patching command from said PROM; and
e. executing the patched boot code.

2. A method according to claim 1, where the patching command includes two parameters: data and address.

3. A method according to claim 1, where the patching command includes three parameters: data, start address, and data-length.

4. A method according to claim 1, where the PROM is an OTP.

5. A method according to claim 1, where the reading of the patching command(s) is preformed after starting to execute the boot code from the memory and as an execution command of said boot code.

6. A method for patching a boot code stored on ROM comprising the steps of:
a. storing at least one patching command for said boot code in a PROM;
b. storing a lookup table listing intended boot code address(es) of said at least one patching command in said PROM;
c. copying said lookup table from said PROM to a memory;
d. reading said lookup table from said memory; and
e. executing said boot code from ROM, while executing said at least one patching command from said PROM instead of at least one command of said boot code having said boot code address listed in said lookup table.

7. A method according to claim 6, where the patching command includes two parameters: data and address.

8. A method according to claim 6, where the patching command includes three parameters: data, start address, and data-length.

9. A method according to claim 6, where the PROM is an OTP.

10. A method for patching a boot code stored on ROM comprising the steps of:
a. storing a lookup table, on a PROM, listing at least one patching command, and its intended boot code address, for patching said boot code;
b. copying said lookup table from said PROM to a memory;
c. reading said lookup table from said memory; and
d. executing said boot code from ROM, while executing said at least one patching command from said lookup table in memory instead of at least one command of said boot code having said boot code address listed in said lookup table.

11. A method according to claim 10, where the patching command includes two parameters: data and address.

12. A method according to claim 10, where the patching command includes three parameters: data, start address, and data-length.

13. A method according to claim 10, where the PROM is an OTP.

14. A method for patching a boot code stored on ROM comprising the steps of:
a. storing a lookup table, on a PROM, listing at least one patching command, and its intended boot code address, for patching said boot code;
b. reading said lookup table from said PROM; and
c. executing said boot code from ROM, while executing said at least one patching command, from said lookup table in said PROM, instead of at least one command of said boot code having said boot code address listed in said lookup table.

15. A method according to claim 14, where the patching command includes two parameters: data and address.

16. A method according to claim 14, where the patching command includes three parameters: data, start address, and data-length.

17. A method according to claim 14, where the PROM is an OTP.

18. A system for patching a boot code stored on ROM comprising:
a. a ROM for storing said boot code;
b. a PROM for storing patching commands;
c. a memory capable of storing said boot code and said patching commands; and
d. a controller for loading said boot code from said ROM to said memory, and for patching said boot code in said memory with patching commands from said PROM.

19. A system according to claim 18, where the PROM is an OTP.

20. A system for patching a boot code stored on ROM comprising:
a. a ROM for storing said boot code;
b. a PROM for storing patching commands;
c. a memory capable of storing said boot code and said patching commands;
d. a controller for loading said boot code from said ROM to said memory; and
e. a processor for patching said boot code with said patching commands from said PROM and for executing the patched boot code.

21. A system according to claim 20, where the PROM is an OTP.
